(19) United States
(12) Patent Application Publication
(10) Pub. No.: US 2007/0049244 A1
(43) Pub. Date: Mar. 1, 2007

(54) Subscriber device lock based on carrier billing cycle and resource allocation

(75) Inventor: Lisa D. Kelley, Davie, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/209,508

(22) Filed: Aug. 23, 2005

(51) Int. Cl. H04M 11/00

(52) U.S. Cl. 455/406

(57) ABSTRACT

A wireless subscriber device (100) can include a transceiver (102) and a processor (114) coupled to the transceiver. The processor can be programmed to pre-set (202) the wireless subscriber device to a locked mode if a periodic airtime allocation is exceeded for a current billing cycle and lock (208) the wireless subscriber device if the periodic airtime allocation is exceeded for the current billing cycle. The wireless subscriber device can automatically return (212) to an unlocked mode once a subsequent billing cycle begins. The wireless subscriber device can be a cellular phone, a smart phone, a satellite phone, a two-way paging device, or a wireless internet access device.

### FIELD OF THE INVENTION

This invention relates generally to wireless subscriber device controls, and more particularly to a method and system for locking and unlocking a wireless subscriber device based on an airtime allocation and carrier billing cycle.

### BACKGROUND OF THE INVENTION

A typical cellular phone subscriber or user enters a contract or relationship with a carrier that entitles the user to a predetermined number of allocated minutes or airtime usage per month without an additional fee. There is currently no way for the user to keep from going over their allocated minutes per month. With more and more carriers offering “family plans” that allocate a predetermined number of minutes among several users within a family, repeated overages can be a likely scenario, particularly with a teenager or younger child user that fails to judiciously use their allocation. Such a scenario can incline the account holder of such a family plan to cancel their plan and lead to the loss of the account for the carrier. Handsets or mobile phones today include the ability to lock a handset, and the SyncML specification allows for settings to be editable by the user or an administrator. Nonetheless, there is no system to control this functionality in regards to per minute usage.

### SUMMARY OF THE INVENTION

Embodiments in accordance with the present invention can provide a method and wireless subscriber device that can control the airtime usage by pre-setting the wireless subscriber device to a locked mode if a periodic airtime allocation is exceeded for a current billing cycle. Embodiments herein can also include notification to the user of the lock mode and further notification as to when it is anticipated to end.

In a first embodiment of the present invention, a method of controlling airtime usage of a wireless subscriber device can include the steps of pre-setting the wireless subscriber device to a locked mode if a periodic airtime allocation is exceeded for a current billing cycle, and locking the wireless subscriber device if the periodic airtime allocation is exceeded for the current billing cycle. The method can further include the step of automatically returning the wireless subscriber device to an unlocked mode once a subsequent billing cycle begins. Note, a password such as a pin can be used to enable a user or other authorized user to perform the step of pre-setting. The step of pre-setting can be done by either a user or a carrier and the carrier can optionally charge a fee for enabling such feature. The wireless subscriber device can also enable the wireless subscriber device to call or contact emergency services or a carrier service notwithstanding being in the locked mode. Further note, the periodic airtime allocation can apply to any one among a cellular airtime allocation, a SMS messaging allocation, a wireless email allocation, and a wireless internet browsing allocation. In one arrangement the periodic airtime allocation can be a predetermined number of minutes or a predetermined amount of data transfer and the billing cycle can be monthly. If a “family plan” is used, the method can also include the step of collectively monitoring a plurality of wireless subscribers devices including the wireless subscriber device for the periodic airtime allocation.

In a second embodiment of the present invention, a wireless subscriber device can include a transceiver and a processor coupled to the transceiver. The processor can be programmed to pre-set the wireless subscriber device to a locked mode if a periodic airtime allocation is exceeded for a current billing cycle and lock the wireless subscriber device if the periodic airtime allocation is exceeded for the current billing cycle. The wireless subscriber device can automatically return to an unlocked mode once a subsequent billing cycle begins. The wireless subscriber device can be any among a cellular phone, a smart phone, a satellite phone, a two-way paging device, and a wireless internet access device.

In a third embodiment of the present invention, a cellular phone having a periodic airtime allocation for a predetermined fee can include a transceiver and a processor coupled to the transceiver. The processor can programmed to pre-set the wireless subscriber device to a locked mode if the periodic airtime allocation is exceeded for a current billing cycle and lock the wireless subscriber device for basic airtime services if the periodic airtime allocation is exceeded for the current billing cycle. The cellular phone can be further programmed to automatically return the cellular phone to an unlocked mode once a subsequent billing cycle begins. Note, the cellular phone can be enabled to call or contact emergency services or a carrier service notwithstanding being in the locked mode.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a wireless subscriber device having a lock feature in accordance with an embodiment of the present invention.

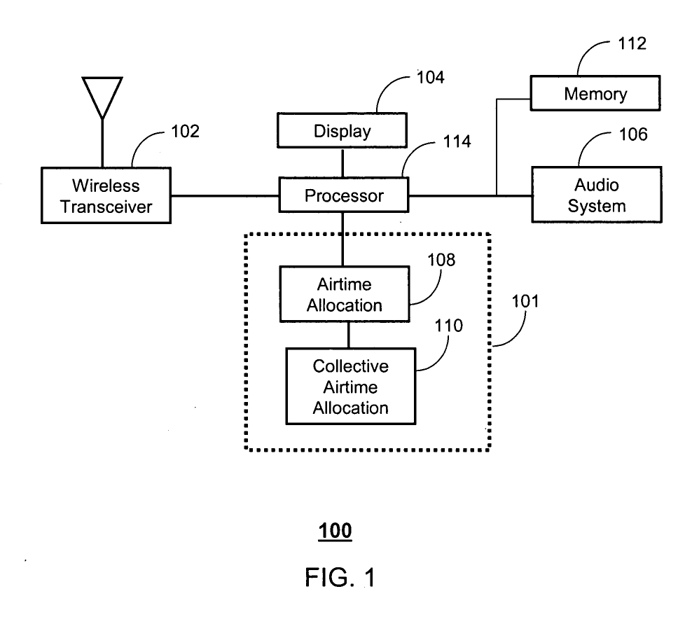

FIG. 2 is a flow chart illustrating a method of controlling airtime usage of a wireless subscriber device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

In one embodiment of the present invention, a wireless subscriber device 100 can be embodied as a selective call radio (SCR) such as a cellular phone, a smart phone, a satellite phone, a two-way paging device, a wireless internet access device, or practically any other wireless device that can subscribe to a carrier service. The wireless subscriber device can include a wireless transceiver 102 for communicating with a conventional radio communication system, a display 104 for conveying images to a user of the wireless subscriber device 100, an audio system 106 for receiving and conveying audible signals to and from the user of the wireless subscriber device 100, a memory 112 for storing and processing data, and a processor 114 coupled to the foregoing components 102-112 for control thereof. The wireless subscriber device can further include a memory 101 that contains data and a program for locking the wireless subscriber device 100 in accordance with a method 200 (further described below) based on exceeding an airtime allocation 108 or a collective airtime allocation 110 for the subscriber device and other subscriber devices associated with wireless subscriber device (e.g., devices belonging to a family plan). Note, although a separate memory 101 is shown, the data and program for this locking feature can alternatively be included in memory 112 instead.

Operationally, a user (or other person with control over the wireless subscriber device or handset 100) can preset the handset to a “locked mode” once the allocated airtime (typically in minutes) is reached for a current billing cycle (typically on a monthly basis). Once the next billing cycle starts, the handset 100 can be unlocked or placed in an unlocked mode and standard calls can be allowed again. A password such as a pin number can be used to avoid unauthorized tampering with this locking feature. For example, the lock function can be secured with a PIN so that a parent or administrator can keep it from being changed. Notwithstanding being in a locked mode, the wireless subscriber device 100 can allow calls to emergency services or the carrier or for other “free” services. For example, if the subscriber has a subscription for “unlimited” in-network service, then calls to other subscribers within the carrier's network can be enabled despite being in a locked mode.

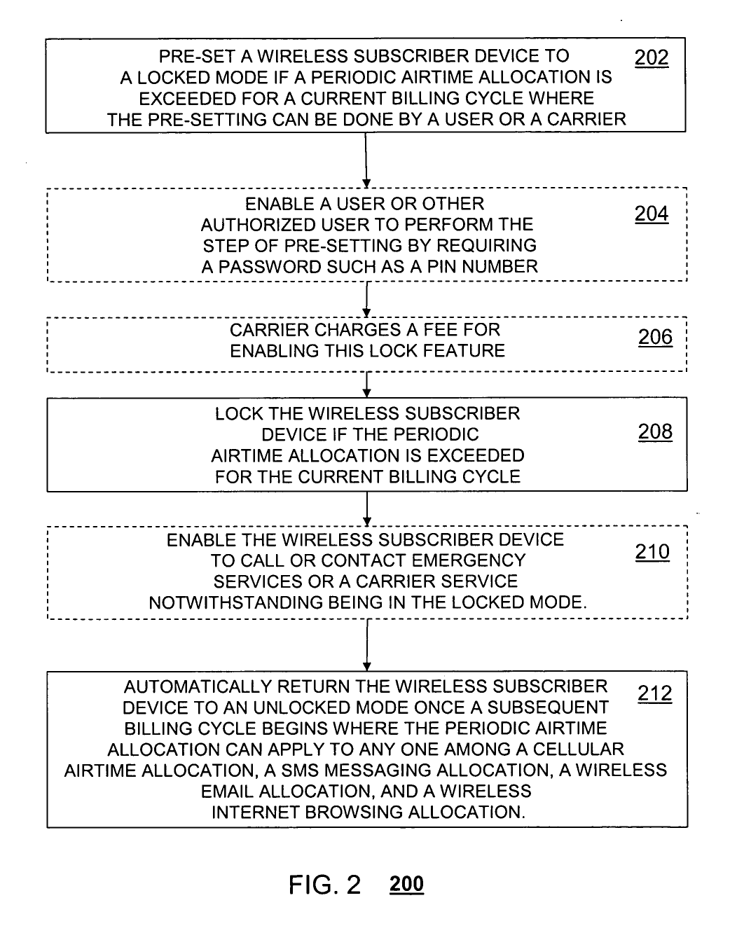

Referring to FIG. 2, a wireless subscriber device 100 can operate in accordance with a method 200 of controlling airtime usage. The method 200 can include the step 202 of pre-setting the wireless subscriber device to a locked mode if a periodic airtime allocation is exceeded for a current billing cycle, and locking the wireless subscriber device if the periodic airtime allocation is exceeded for the current billing cycle at step 208. Optionally, the method 204 can further include the step 204 of enabling a user or other authorized user to pre-set the locked mode feature by requiring a password such as a PIN number. Note, the step of pre-setting can be done by either a user or a carrier. A carrier can also optionally charge a fee for enabling this lock feature at step 206 so that the user will not be subject to overage charges that exceed a periodic airtime allocation. The wireless subscriber device can also enable the wireless subscriber device to call or contact emergency services or a carrier service or other free services notwithstanding being in the locked mode at step 210. The method 200 can further include the step 212 of automatically returning the wireless subscriber device to an unlocked mode once a subsequent billing cycle begins. Further note, the periodic airtime allocation can apply to any one among a cellular airtime allocation, a SMS messaging allocation, a wireless email allocation, and a wireless internet browsing allocation. In one arrangement the periodic airtime allocation can be a predetermined number of minutes or a predetermined amount of data transfer and the billing cycle can be monthly although other allocation amounts and periodic billing cycles are certainly contemplated within the scope of claims herein. If a “family plan” is used, the method can also include the step of collectively monitoring a plurality of wireless subscribers devices including the wireless subscriber device for the periodic airtime allocation. In other words, if multiple phones on a plan have a predetermined periodic airtime allocation that are shared collectively, a carrier can easily track such collective allocation and signal the multiple phones to implement the locked mode when the periodic airtime allocation is collectively exceeded. Alternatively, if each phone tracks their usage, each phone can contact each other to track usage collectively (unless “shares” of the collective allocation is already predetermined for each phone for a given plan).

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of controlling airtime usage of a wireless subscriber device, comprising the steps of:
pre-setting the wireless subscriber device to a locked mode if a periodic airtime allocation is exceeded for a current billing cycle; and
locking the wireless subscriber device if the periodic airtime allocation is exceeded for the current billing cycle.

2. The method of claim 1, wherein the method further comprises the step of automatically returning the wireless subscriber device to an unlocked mode once a subsequent billing cycle begins.

3. The method of claim 1, wherein the method further comprises the step of requiring a password to enable a user to perform the step of pre-setting.

4. The method of claim 1, wherein the method further comprises the step of enabling the wireless subscriber device to call or contact emergency services or a carrier service notwithstanding being in the locked mode.

5. The method of claim 1, wherein the periodic airtime allocation can apply to any one among a cellular airtime allocation, a SMS messaging allocation, a wireless email allocation, and a wireless internet browsing allocation.

6. The method of claim 1, wherein the periodic airtime allocation is a predetermined number of minutes or a predetermined amount of data transfer and the billing cycle is monthly.

7. The method of claim 1, wherein the step of pre-setting is done by either a user or a carrier.

8. The method of claim 1, wherein a carrier charges a fee for enabling the step of pre-setting.

9. The method of claim 1, wherein the method further comprises the step of collectively monitoring a plurality of wireless subscribers devices including the wireless subscriber device for the periodic airtime allocation.

10. A wireless subscriber device, comprising:
a transceiver;
a processor coupled to the transceiver, wherein the processor is programmed to:
pre-set the wireless subscriber device to a locked mode if a periodic airtime allocation is exceeded for a current billing cycle; and
lock the wireless subscriber device if the periodic airtime allocation is exceeded for the current billing cycle.

11. The wireless subscriber device of claim 10, wherein the processor is further programmed to automatically return the wireless subscriber device to an unlocked mode once a subsequent billing cycle begins.

12. The wireless subscriber device of claim 10, wherein the processor is further programmed to require a password to enable a user to perform the step of pre-setting.

13. The wireless subscriber device of claim 10, wherein the processor is further programmed to enable the wireless subscriber device to call or contact emergency services or a carrier service notwithstanding being in the locked mode.

14. The wireless subscriber device of claim 10, wherein the periodic airtime allocation can apply to any one among a cellular airtime allocation, a SMS messaging allocation, a wireless email allocation, and a wireless internet browsing allocation.

15. The wireless subscriber device of claim 10, wherein the periodic airtime allocation is a predetermined number of minutes or a predetermined amount of data transfer and the billing cycle is monthly.

16. The wireless subscriber device of claim 10, wherein the wireless subscriber can be pre-set for a locked mode by either a user or a carrier.

17. The wireless subscriber device of claim 10, wherein the wireless subscriber device is among a cellular phone, a smart phone, a satellite phone, a two-way paging device, and a wireless internet access device.

18. A cellular phone having a periodic airtime allocation for a predetermined fee, comprising:
a transceiver;
a processor coupled to the transceiver, wherein the processor is programmed to:
pre-set the wireless subscriber device to a locked mode if the periodic airtime allocation is exceeded for a current billing cycle; and
lock the wireless subscriber device for basic airtime services if the periodic airtime allocation is exceeded for the current billing cycle.

19. The cellular phone of claim 18, wherein the processor is further programmed to automatically return the cellular phone to an unlocked mode once a subsequent billing cycle begins.

20. The cellular phone of claim 17, wherein the processor is further programmed to enable the cellular phone to call or contact emergency services or a carrier service notwithstanding being in the locked mode.
